(19) United States
(12) Patent Application Publication
(10) Pub. No.: US 2018/0176172 A1
(43) Pub. Date: Jun. 21, 2018

(54) SYSTEMS AND METHODS FOR SHARING CONTENT

(71) Applicant: Facebook, Inc., Menlo Park, CA (US)

(72) Inventor: Allen Edward Jordan, San Francisco, CA (US)

(21) Appl. No.: 15/380,591

(22) Filed: Dec. 15, 2016

(51) Int. Cl. H04L 12/58; G06F 3/0484; G06F 17/24

(52) U.S. Cl. CPC H04L 51/32; H04L 51/10; G06F 17/2235; G06F 17/24; G06F 3/04842

(57) ABSTRACT

Systems, methods, and non-transitory computer-readable media can present a content item on a display. A composer is presented with the content item on the display. A selection of a portion of the content item is received as selected content. The selected content is automatically copied into the composer as entered content.

### FIELD OF THE INVENTION

The present technology relates to the field of social networking systems. More particularly, the present technology relates to systems and methods for sharing content.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

Users of a social networking system can be provided with a graphical user interface to view and interact with the social networking system. For example, the graphical user interface can be presented via a mobile application on a user's mobile device. The graphical user interface can provide users with the ability to post, view, and otherwise interact with content on the social networking system.

### SUMMARY

Various embodiments of the present disclosure can include systems, methods, and non-transitory computer readable media configured to present a content item on a display. A composer is presented with the content item on the display. A selection of a portion of the content item is received as selected content. The selected content is automatically copied into the composer as entered content.

In an embodiment, receiving the selection of the portion of the content item as selected content comprises: presenting a selection indicator on the content item, the selection indicator visually indicating selected content in the content item; and receiving adjustments to the selection indicator to revise the selected content.

In an embodiment, the copying the selected content into the composer as entered content comprises: revising the entered content automatically as the selection indicator is adjusted.

In an embodiment, a social network post comprising the entered content is generated.

In an embodiment, the social network post is generated in response to a user input on the composer.

In an embodiment, the social network post further comprises content item information.

In an embodiment, the content item information comprises a title of the content item.

In an embodiment, the content item information comprises a link to the content item.

In an embodiment, the selected content comprises textual content selected by a user.

In an embodiment, the selected content comprises an image selected by a user.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including a content sharing module, according to an embodiment of the present disclosure.

FIGS. 2A-C illustrate an example scenario associated with presenting a composer for sharing content to a social networking system, according to an embodiment of the present disclosure.

FIGS. 3A-B illustrate an example scenario associated with selecting content for posting to a social networking system, according to an embodiment of the present disclosure.

FIG. 4 illustrates an example scenario associated with selecting non-text content for posting to a social networking system, according to an embodiment of the present disclosure.

FIG. 5 illustrates an example method associated with selecting content for posting to a social networking system, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Systems and Methods for Sharing Content

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

Users of a social networking system can be provided with a graphical user interface to view and interact with the social networking system. For example, the graphical user interface can be presented via a mobile application on a user's mobile device. The graphical user interface can provide users with the ability to post, view, and otherwise interact with content on the social networking system. An interface (or features of an interface) may also be provided through which users can post content to a social networking system from third party content sources. For example, users may wish to share links to interesting news articles, images, and/or videos to the social networking system. By allowing users to share content from third party content sources, the social networking system can act as a central location in which users can view the most interesting content from many different content sources. As users post and share interesting content from various sources, interaction on the social networking system can be encouraged.

It continues to be an important interest for a social networking system to encourage users to share and interact with content on the social networking system. Continued user sharing of content to the social networking is an important aspect of maintaining and growing interest in and participation on the social networking system. A related issue is the issue of providing users with graphical user interfaces that allow users to post and share content to the social networking in an easy and intuitive manner that will encourage further content sharing by users. Conventional graphical user interfaces and their functionality can be unintuitive, cumbersome to navigate, visually unattractive, or otherwise functionally suboptimal, leading to frustration and loss of interest by users.

An improved approach rooted in computer technology overcomes the foregoing and other disadvantages associated with conventional approaches specifically arising in the realm of computer technology. In general, a graphical user interface can be presented to a user in which a content item is presented in a content browser, and a composer is overlaid on top of the content item. The composer can be used by a user to share content to a social networking system. The composer can allow a user to select content within the content item. When the user selects content within the content item, the selected content can be automatically copied into the composer so that the user can easily share the selected content to a social networking system. Once content is entered into the composer, the user can select an interface element (e.g., a “Post” button) to post the selected content to the social networking system. By displaying a composer with a content item, and allowing the user to enter content into the composer by selecting content within the content item, various advantages are provided. For example, on a mobile device, display space is limited and, typically, only one application is presented at a time. Under conventional approaches, in order to share content from a third party content source to a social networking system, a user would have to copy content from a browser application and then paste it into a separate social networking system application. This requires numerous interactions and steps by the user. Conversely, the presently disclosed technology allows a user to easily select and share content from a content item with minimal difficulty. In certain embodiments, the composer can be implemented as an extension to a third party content browser application (e.g., a web browser, a newspaper browser application, a magazine browser application, an e-reader, etc.). In various embodiments, the composer can be implemented as a feature on a content browser provided by a social networking system.

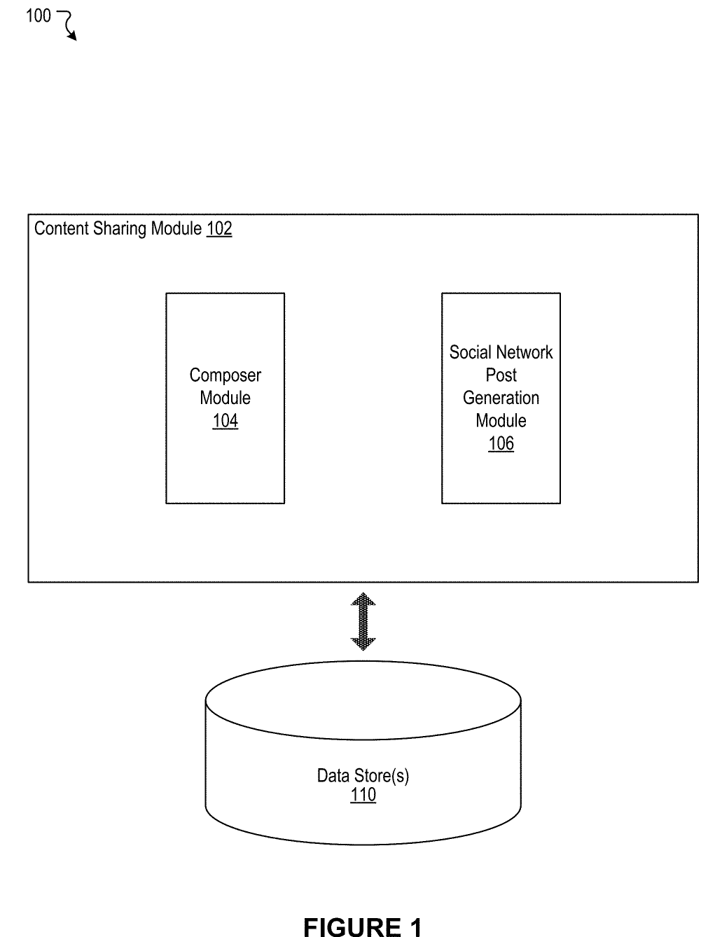

FIG. 1 illustrates an example system 100 including a content sharing module 102, according to an embodiment of the present disclosure. The content sharing module 102 can be configured to provide a composer through which a user can post content to a social networking system. In certain embodiments, the composer can be presented in the same display as a content item. For example, a composer can be overlaid on top of a content item being presented in the content browser. The user can enter content into the composer, and then share the entered content to a social networking system by, for example, selecting a button to post the entered content to a social networking system. In certain embodiments, the user can select content within the content item, and the selected content can then be automatically copied into the composer as entered content. In certain embodiments, when the user posts and/or publishes the content entered into the composer to the social networking system, the entered content can be presented with additional content item information, such as a link to the original content item.

As shown in the example of FIG. 1, the content sharing module 102 can include a composer module 104 and a social network post generation module 106. In some instances, the example system 100 can include at least one data store 110. The components (e.g., modules, elements, etc.) shown in this figure and all figures herein are exemplary only, and other implementations may include additional, fewer, integrated, or different components. Some components may not be shown so as not to obscure relevant details. In various embodiments, one or more of the functionalities described in connection with the content sharing module 102 can be implemented in any suitable combinations.

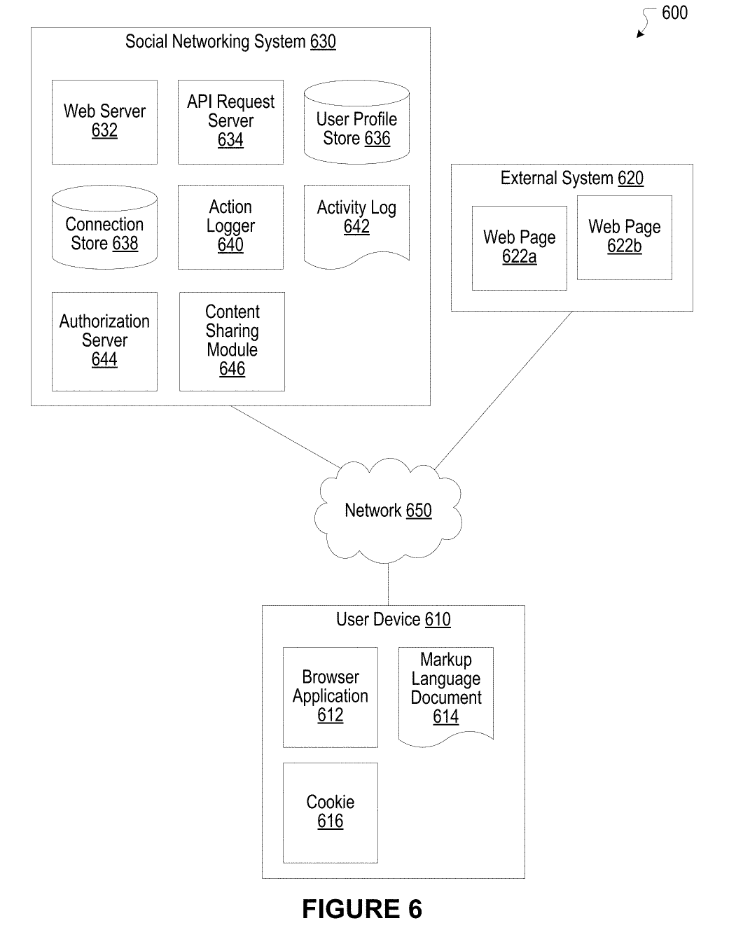

In some embodiments, the content sharing module 102 can be implemented, in part or in whole, as software, hardware, or any combination thereof. In general, a module, as discussed herein, can be associated with software, hardware, or any combination thereof. In some implementations, one or more functions, tasks, and/or operations of modules can be carried out or performed by software routines, software processes, hardware, and/or any combination thereof. In some cases, the content sharing module 102 can be implemented, in part or in whole, as software running on one or more computing devices or systems, such as on a user or client computing device. For example, the content sharing module 102, or at least a portion thereof, can be implemented as or within an application (e.g., app), a program, or an applet, etc., running on a user computing device or a client computing system, such as the user device 610 of FIG. 6. In another example, the content sharing module 102, or at least a portion thereof, can be implemented using one or more computing devices or systems that include one or more servers, such as network servers or cloud servers. In some instances, the content sharing module 102 can, in part or in whole, be implemented within or configured to operate in conjunction with a social networking system (or service), such as the social networking system 630 of FIG. 6. It should be understood that there can be many variations or other possibilities.

The content sharing module 102 can be configured to communicate and/or operate with the at least one data store 110, as shown in the example system 100. The data store 110 can be configured to store and maintain various types of data. In some implementations, the data store 110 can store information associated with the social networking system (e.g., the social networking system 630 of FIG. 6). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data. In some embodiments, the data store 110 can store information that is utilized by the content sharing module 102. For example, the data store 110 can store one or more graphical user interfaces, content items, and the like. It is contemplated that there can be many variations or other possibilities.

The composer module 104 can be configured to provide a composer that can be used by a user to enter content for sharing to a social networking system. In certain embodiments, the composer can be presented with a content browser that is displaying a content item. When a user is viewing a content item in the content browser, the user may be provided with a selectable interface element (e.g., a button) that can be selected to open and/or close the composer. In certain embodiments, the composer can have an expanded configuration and a contracted configuration. For example, in the expanded configuration, the user can be provided with a keyboard to enter content into the composer (e.g., by typing text, or selecting an emoji). In the contracted configuration, the composer can occupy less display space such that the user can more easily view a content item being displayed with the composer. This may be particularly advantageous on a mobile device with a touchscreen, in which display space may be limited. The user can be provided with a selectable interface element (e.g., a button) that causes the composer to switch between the expanded and contracted configurations.

In certain embodiments, the composer module 104 can be configured such that when a user selects content from a content item being displayed, the selected content is automatically copied into the composer as entered content. For example, consider an example scenario in which a user is viewing a news article in a web browser. If the user would like to share a quote from the news article, the user can select the quote (i.e., select the text in the news article). The selected text will automatically be copied into the composer. In this way, the user can easily share the quote without having to manually type the quote into the composer or manually typing or copying the quote into a separate social networking system application. In various embodiments, the composer module 104 can be configured such that any content selected by a user is automatically copied into the composer, including both textual and non-textual content (e.g., images, videos, GIFs, etc.).

In certain embodiments, a selection indicator can be displayed on the content item to allow a user to select content for automatic import into the composer. For example, a portion of the content item can be highlighted, or surrounded by a boundary, to visually demonstrate what portion of the content item is selected. The user can revise the selected content by adjusting the selection indicator (e.g., dragging and dropping the indicator to another location, moving a start point or an end point of the selection indicator, etc.). As the user adjusts the selection indicator, thereby revising the portion of the content item that is selected, the composer can automatically update and revise the content entered into the composer.

The social network post generation module 106 can be configured to generate a social network post comprising content entered into the composer (i.e., “entered content”). The composer can include a selectable interface element (e.g., a “Post” button) through which the user can generate and post a social network post to the social networking system. For example, a user can enter content into the composer by either using a keyboard or selecting content from a content item being displayed. The user can then select a “Post” button to generate and post to a social networking system a social network post comprising the entered content. In certain embodiments, the social network post can include the entered content as well as additional content item information, such as a link to the content item. For example, if the user has selected a quote from a news article, the selected quote can be included in the social network post along with a link to the news article.

In certain embodiments, before a user posts a social network post to the social networking system, the user may be provided with the ability to define privacy settings for the social network post. For example, the user can select whether the post should be made publicly available, or available only to the user's connections on the social networking system, or available only to certain users on the social networking system. The social network post can be a post posted to a timeline of the user on the social networking system, a post posted to a timeline of another user on the social networking system, and/or a message to other users on the social networking system.

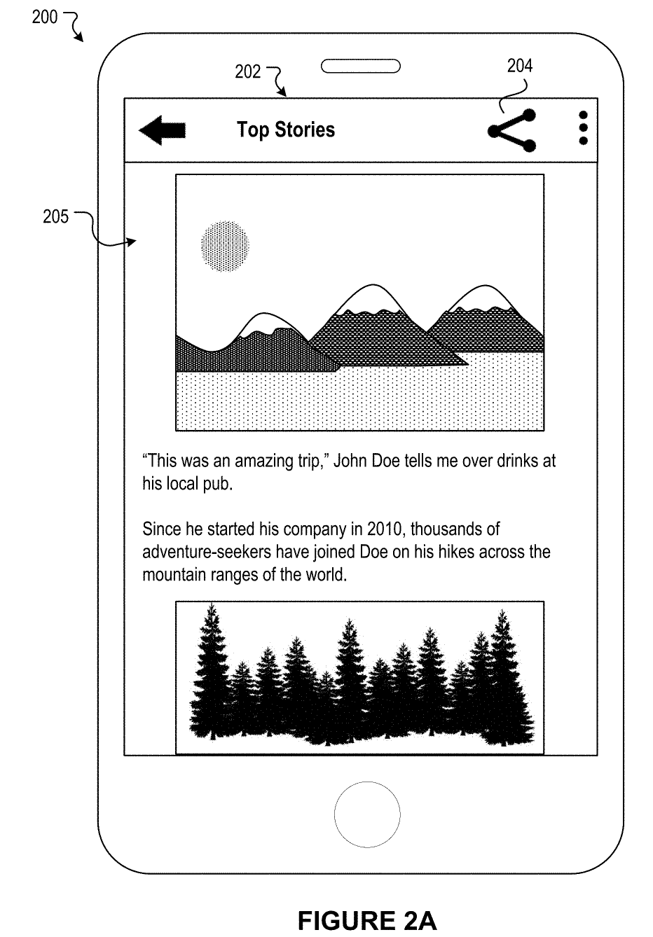

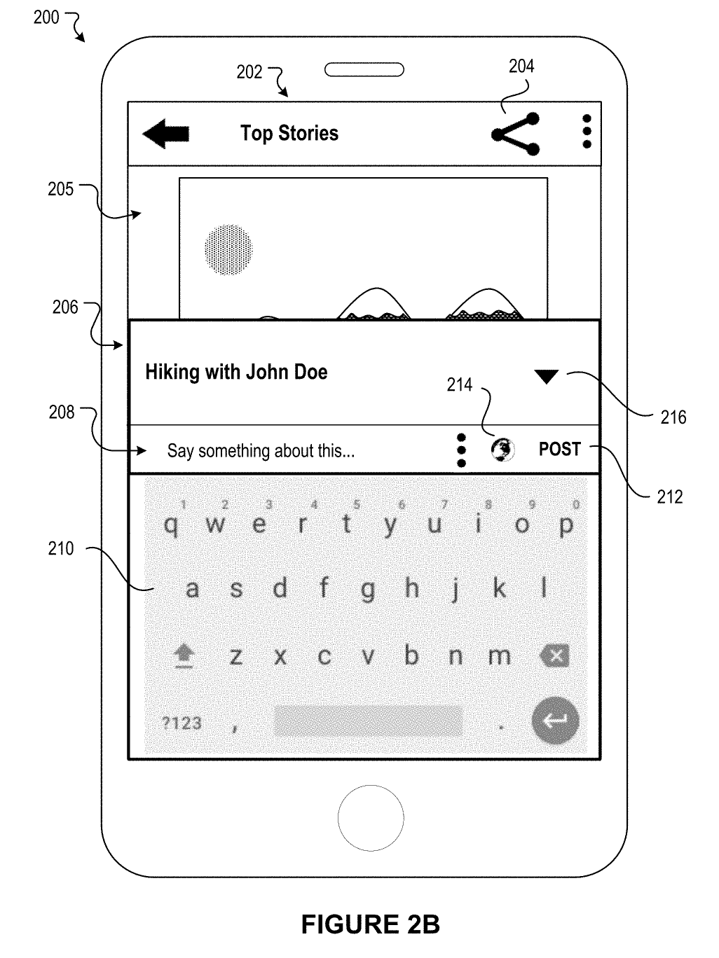

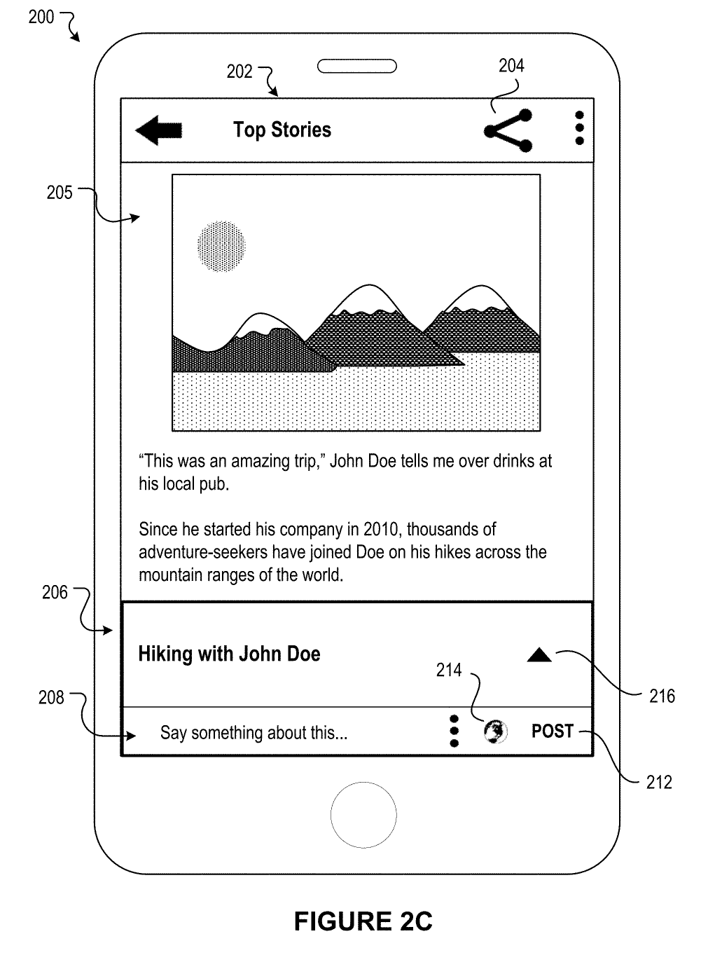

FIGS. 2A-C illustrate an example scenario 200 associated with presenting a composer for sharing content to a social networking system. As shown in FIG. 2A, the example scenario 200 includes a graphical user interface 202 on a mobile device in which a content item 205 is displayed. In this case, the content item 205 is a news article that includes both textual and image elements. The graphical user interface 202 includes a composer button 204 that allows a user to open a composer.

In FIG. 2B, a user has selected the composer button 204 and opened up a composer 206. The composer 206 has been pre-populated with information about the content item 205 (i.e., a news article titled “Hiking with John Doe.”) The composer 206 includes a content entry field 208. In FIG. 2B, the composer 206 is in an expanded configuration such that a keyboard 210 is displayed. The user can use the keyboard 210 to enter content into the content entry field 208. A toggle button 216 can be selected by the user to toggle between expanded and contracted configurations of the composer 206. The composer also includes a “POST” button 212. When the user selects the “POST” button 212, a social network post can be generated and posted to a social networking system which includes a link to the content item and any content entered into the content entry field 208. The composer 206 also includes a privacy setting button 214 through which the user can set privacy settings for the social network post.

In FIG. 2C, the user has selected the toggle button 216 to toggle the composer 206 from the expanded configuration to a contracted configuration. In the contracted configuration, the keyboard 210 is no longer visible and the composer 206 occupies less display space. By toggling the composer 206 into the contracted configuration, the user can more easily view the content item 205.

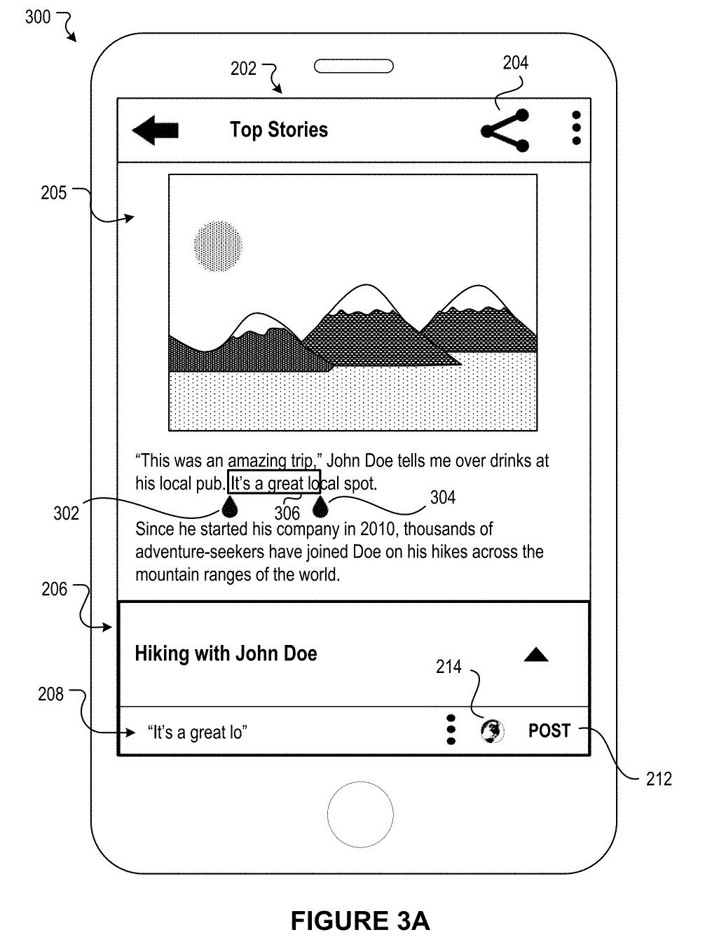

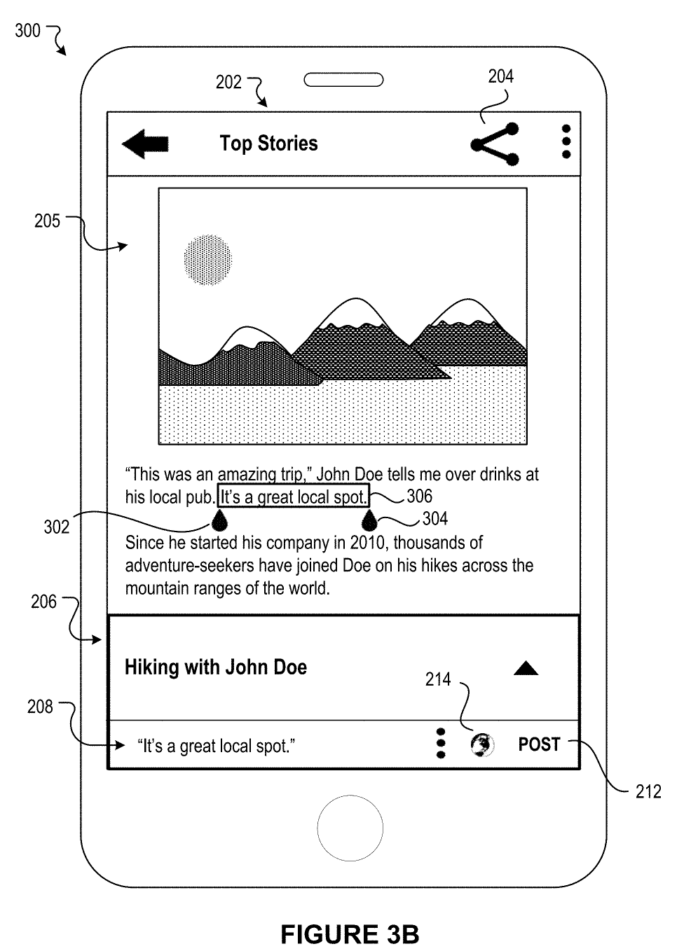

FIGS. 3A-B illustrate an example scenario 300 associated with selecting content for posting to a social networking system. In FIG. 3A, the composer 206 is in a contracted configuration such that the user can more easily see the content item 205. The user would like to select a quote in the content item 205 for sharing to a social networking system. In FIG. 3A, the user has begun selecting some text. The selected content is demarcated by a start marker 302, an end marker 304, and a selection indicator 306. The selection indicator 306 can include, for example, a boundary of the selected content (as shown in the figures), and/or highlighting of the selected content. The user can select content in the content item 205 by, for example, tapping on the content item 205 to bring up the start marker 302, end marker 304, and selection indicator 306. The user can then drag the start marker 302 and/or the end marker 304 to adjust the size and/shape of the selection indicator 306 and select the desired content.

It can be seen in FIG. 3A that the user has selected a portion of the sentence “It's a great local spot.” The selected content is automatically copied into the content entry field 208. In FIG. 3B, the user has dragged the end marker 304 to the right so that the selection indicator 306 encompasses the entire sentence. The composer 206 is automatically updated such that the entire sentence now appears as entered content in the content entry field 208. By selecting content in the content item 205, the user can automatically enter content into the content entry field 208 without having to manually type content into the field or manually copy and paste content into the field.

If the user is satisfied with the entered content in the content entry field 208, the user can select the “POST” button 212 to generate and post a social network post to a social networking system. The social network post can include the entered content in the content entry field 208. The social network post can also include information about the original content item 205, e.g., a title of the content item 205 and/or a link to the content item 205. Alternatively, if the user would like to make changes to the entered content in the content entry field 208, the user can select alternative content in content item 205. The user can also change the entered content by expanding the composer into the expanded configuration and manually entering content or removing entered content using, for example, a keyboard (as was depicted in FIG. 2B).

FIG. 4 illustrates an example scenario 400 associated with selecting non-textual content for posting to a social networking system. As noted above, in various embodiments, any content selected by a user can be automatically entered into the content entry field 208, including both textual and non-textual content. In FIG. 4, a user has selected an image 404, as indicated by a selection indicator 402. The image 404 has been automatically copied into the content entry box 208.

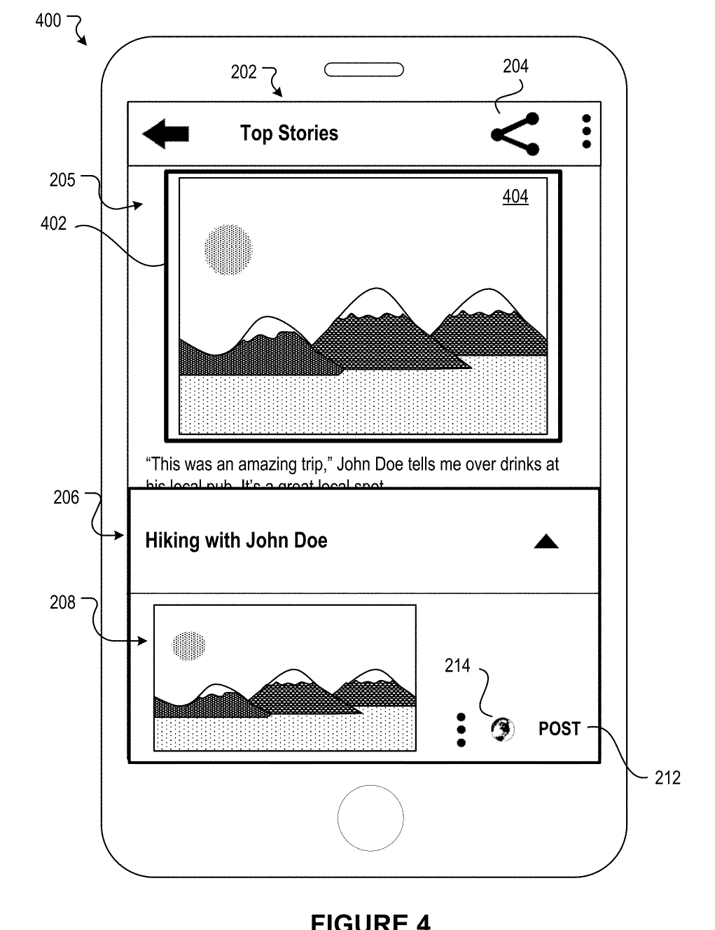

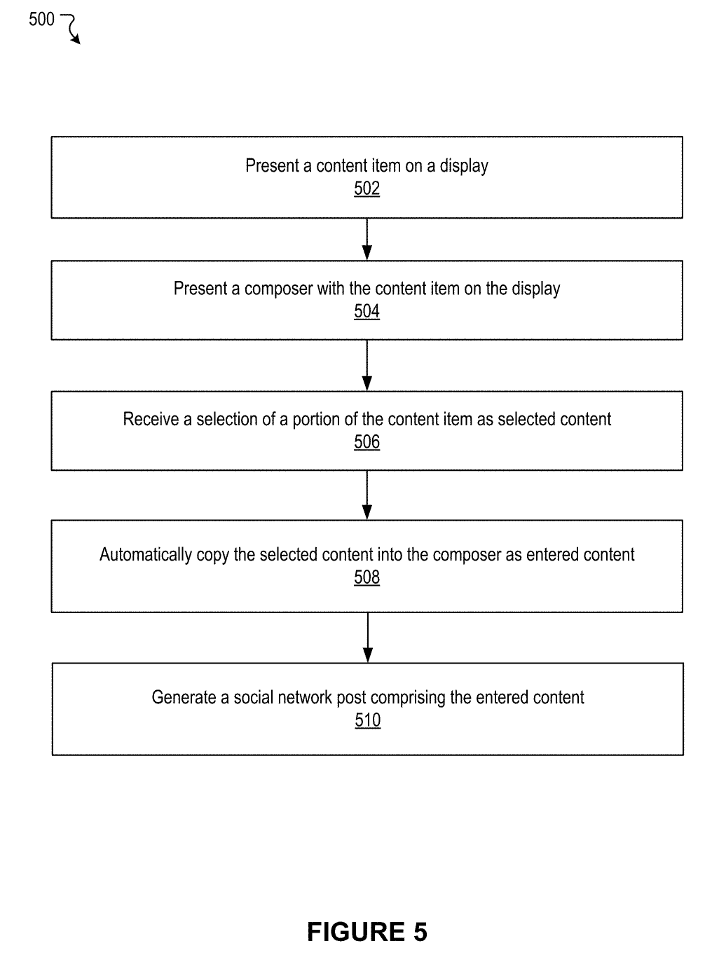

FIG. 5 illustrates an example method 500 associated with selecting content for posting to a social networking system, according to an embodiment of the present disclosure. It should be appreciated that there can be additional, fewer, or alternative steps performed in similar or alternative orders, or in parallel, within the scope of the various embodiments discussed herein unless otherwise stated.

At block 502, the example method 500 can present a content item on a display. At block 504, the example method 500 can present a composer with the content item on the display. At block 506, the example method 500 can receive a selection of a portion of the content item as selected content. At block 508, the example method 500 can automatically copy the selected content into the composer as entered content. At block 510, the example method 500 can generate a social network post comprising the entered content.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, according to an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a content sharing module 646. The content sharing module 646 can, for example, be implemented as the content sharing module 102, as discussed in more detail herein. As discussed previously, it should be appreciated that there can be many variations or other possibilities. For example, in some embodiments, one or more functionalities of the content sharing module 646 can be implemented in the user device 610.

### Hardware Implementation

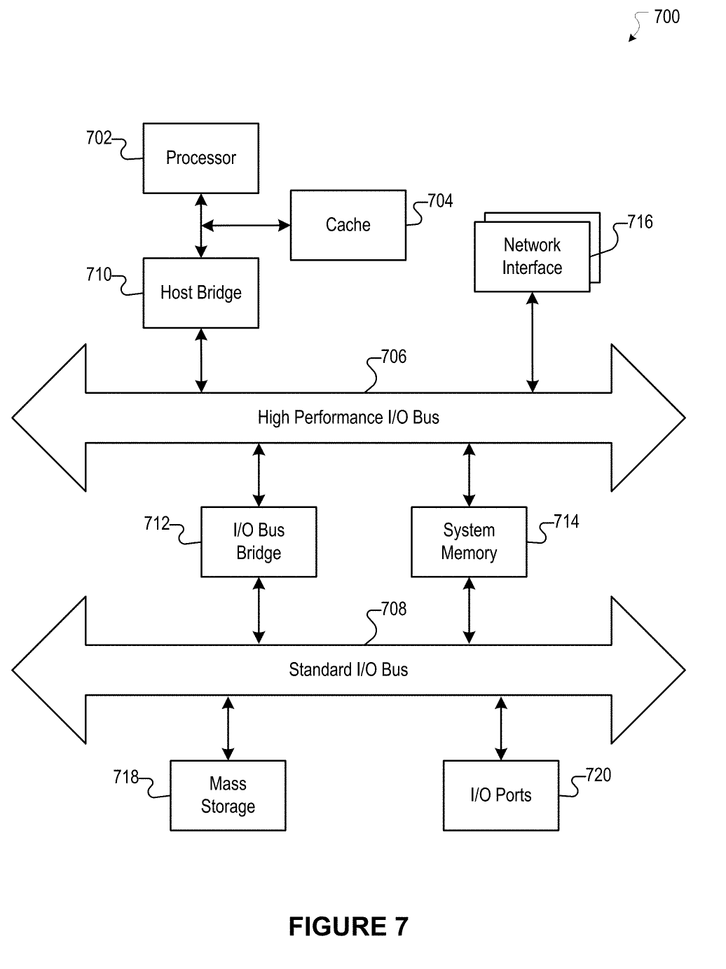

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
presenting, by a computing system, a content item on a display;
presenting, by the computing system, a composer with the content item on the display;
receiving, by the computing system, a selection of a portion of the content item as selected content; and
automatically copying, by the computing system, the selected content into the composer as entered content.

2. The computer-implemented method of claim 1, wherein receiving the selection of the portion of the content item as selected content comprises:
presenting a selection indicator on the content item, the selection indicator visually indicating selected content in the content item; and
receiving adjustments to the selection indicator to revise the selected content.

3. The computer-implemented method of claim 2, wherein the copying the selected content into the composer as entered content comprises:
revising the entered content automatically as the selection indicator is adjusted.

4. The computer-implemented method of claim 1, further comprising generating a social network post comprising the entered content.

5. The computer-implemented method of claim 4, wherein the social network post is generated in response to a user input on the composer.

6. The computer-implemented method of claim 4, wherein the social network post further comprises content item information.

7. The computer-implemented method of claim 6, wherein the content item information comprises a title of the content item.

8. The computer-implemented method of claim 6, wherein the content item information comprises a link to the content item.

9. The computer-implemented method of claim 1, wherein the selected content comprises textual content selected by a user.

10. The computer-implemented method of claim 1, wherein the selected content comprises an image selected by a user.

11. A system comprising:
at least one processor; and
a memory storing instructions that, when executed by the at least one processor, cause the system to perform a method comprising:
presenting a content item on a display;
presenting a composer with the content item on the display;
receiving a selection of a portion of the content item as selected content; and
automatically copying the selected content into the composer as entered content.

12. The system of claim 11, wherein receiving the selection of the portion of the content item as selected content comprises:
presenting a selection indicator on the content item, the selection indicator visually indicating selected content in the content item; and
receiving adjustments to the selection indicator to revise the selected content.

13. The system of claim 12, wherein the copying the selected content into the composer as entered content comprises:
revising the entered content automatically as the selection indicator is adjusted.

14. The system of claim 11, further comprising generating a social network post comprising the entered content.

15. The system of claim 14, wherein the social network post is generated in response to a user input on the composer.

16. A non-transitory computer-readable storage medium including instructions that, when executed by at least one processor of a computing system, cause the computing system to perform a method comprising:
presenting a content item on a display;
presenting a composer with the content item on the display;
receiving a selection of a portion of the content item as selected content; and
automatically copying the selected content into the composer as entered content.

17. The non-transitory computer-readable storage medium of claim 16, wherein receiving the selection of the portion of the content item as selected content comprises:
presenting a selection indicator on the content item, the selection indicator visually indicating selected content in the content item; and
receiving adjustments to the selection indicator to revise the selected content.

18. The non-transitory computer-readable storage medium of claim 17, wherein the copying the selected content into the composer as entered content comprises:
revising the entered content automatically as the selection indicator is adjusted.

19. The non-transitory computer-readable storage medium of claim 16, further comprising generating a social network post comprising the entered content.

20. The non-transitory computer-readable storage medium of claim 19, wherein the social network post is generated in response to a user input on the composer.
